(19) United States
(12) Patent Application Publication
(10) Pub. No.: US 2012/0106845 A1
(43) Pub. Date: May 3, 2012

(54) Replacing word with image of word

(76) Inventor: Prakash Reddy, Fremont, CA (US)

(21) Appl. No.: 12/916,530

(22) Filed: Oct. 30, 2010

(51) Int. Cl. G06K 9/18

(52) U.S. Cl. 382/182

(57) ABSTRACT

First data represents an image of text including words. Second data represents the text in a non-image form. A particular word within the second data is replaced with a corresponding part of the first data representing the image of the particular word.

### BACKGROUND

Text is frequently electronically received in a non-textually editable form. For instance, data representing an image of text may be received. The data may have been generated by scanning a hardcopy of the image using a scanning device. The text is not textually editable, because the data represents an image of the text as opposed to representing the text itself in a textually editable and non-image form, and thus cannot be edited using a word processing computer program, a text editing computer program, and so on. To convert the data to a textually editable and non-image form, optical character recognition (OCR) may be performed on the image, which generates data representing the text in a textually editable and non-image form, so that the data can be edited using a word processing computer program, a texting editing computer program, and so on.

### BRIEF DESCRIPTION OF THE DRAWINGS

FIG. 1 is a diagram illustratively depicting how a word in a non-image form can be replaced by an image of the word, according to an example of the disclosure.

FIG. 2 is a flowchart of a method, according to an example of the disclosure.

FIG. 3 is a diagram of a system, according to an example of the disclosure.

### DETAILED DESCRIPTION

As noted in the background second, data can represent an image of text, as opposed to representing the text itself in a textually editable and non-image form that can be edited using a word processing computer program, a text editing computer program, and so on. To convert the data to a textually editable and non-image form, optical character recognition (OCR) may be performed on the image. Performing OCR on the image generates data representing the text in a textually editable and non-image form, so that the data can be edited using a computer program like a word process computer program or a text editing computer program.

However, OCR is not perfect. That is, even the best OCR techniques do not yield 100% accuracy in converting an image of text to a non-image form of the text. Furthermore, the accuracy of OCR depends at least in part on the quality of the image of text. For example, OCR performed on a cleanly scanned hardcopy of text will likely be more accurate than OCR performed on a faxed copy of the text that contains significant artifacts. Therefore, even the best OCR techniques are likely to yield significantly less than 100% accuracy in converting certain types of images of text to non-image forms of the text.

Disclosed herein are approaches to compensate for these drawbacks of OCR techniques. Specifically, a particular word within data representing text in a non-image form is replaced with a part of an image of the text that corresponds to this word. For instance, first data representing an image of text may be received, and second data representing the text in a non-image form, such as in a textually editable form, may also be received. The second data may be generated by performing OCR on the first data. Each word of the second data is examined. If a word contains an error within the second data, then the word is replaced within the second data with a corresponding part of the first data of the word.

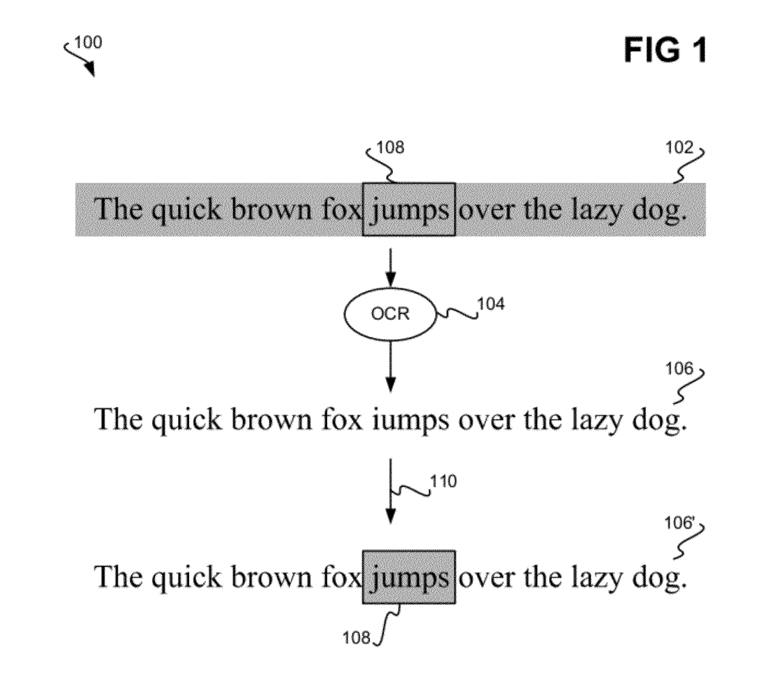

FIG. 1 illustratively depicts how a word in a non-image form can be replaced by an image of the word, according to an example of the disclosure. There is data 102 representing an image of text including the words “The quick brown fox jumps over the lazy dog.” The image is shaded in FIG. 1 just to represent the fact that it is an image, as opposed to textually editable data in non-image form. For instance, the data 102 representing the image may be bitmap data in BMP, JPG, or TIF file format, among other image file formats. The data 102 representing the image is not textually editable by computer programs like word processing and text editing computer programs. In general, then, shading is used in FIG. 1 to convey that a word is represented in image form.

OCR 104 can be performed on the image 102, to generate data 106 of the text in non-image form, and which may be textually editable by a computer program like a word processing computer program or a text editing computer program. The data 106 may be formatted in accordance with the ASCII or Unicode standard, for instance, and may be stored in a TXT, DOC, or RTF file format, among other text-oriented file formats. The data 106 can include a byte, or more than one byte, for each character of the text, in accordance with a standard like the ASCII or Unicode standard, among other standards to commonly represent such characters.

For example, consider the letter “q” in the text. A collection of pixels corresponds to the location of this letter within the image of the data 102. If the image is a black-and-white image, each pixel is on or off, such that the collection of on-and-off pixels forms an image of the letter “q.” Note that this collection of pixels may differ depending on how the data 102 was generated. For instance, one scanning device may scan a hardcopy of the text such that there are little or no artifacts (i.e., extraneous pixels) within the part of the image corresponding to the letter “q.” By comparison, another scanning device may scan the hardcopy such that there are more artifacts within the part of the image corresponding to this letter.

From the perspective of a user, the user is able to easily distinguish the part of each image as corresponding to the letter “q.” However, the portions of the images corresponding to the letter “q” are not identical to one another, and are not in correspondence with any standard. As such, without performing a process like OCR 104, a computing device is unable to discern that the portion of each image corresponds to the letter “q.”

By comparison, consider the letter “q” within the data 106 representing the text in a non-image form that may be textually editable. The letter is in accordance with a standard, like the ASCII or Unicode standard, by which different computing devices know that this letter is in fact the letter “q.” From the perspective of a computing device, the computing device is able to discern that the portion of the data 106 representing this letter indeed represents the letter “q.”

In the data 106 that represents the text in a non-image form, the word “jumps” is incorrectly listed as “iumps.” For instance, during OCR 104, the portion of the image representing the letter “j” may have been erroneously discerned as the letter “i.” Therefore, the word “jumps” is replaced in the data 106 by an image portion 108 of the data 102 corresponding to this word, as indicated by the arrow 110. The data 106 after this replacement has occurred is referenced as the data 106′ in FIG. 1.

Therefore, the data 106′ includes both image data, and textual data in non-image form, whereas the data 102 includes just image data, and the data 106 includes just textual data in non-image form. Specifically, the characters of the words “The quick brown fox” and the words “over the lazy dog” are represented within the data 106′ in non-image form, such as in accordance with a standard like the ASCII or Unicode standard. By comparison, the word “jumps” is represented within the data 106′ in image form, by replacing the word “iumps” represented in non-image form within the data 106 by the image portion 108 within the data 102 corresponding to the word “jumps.”

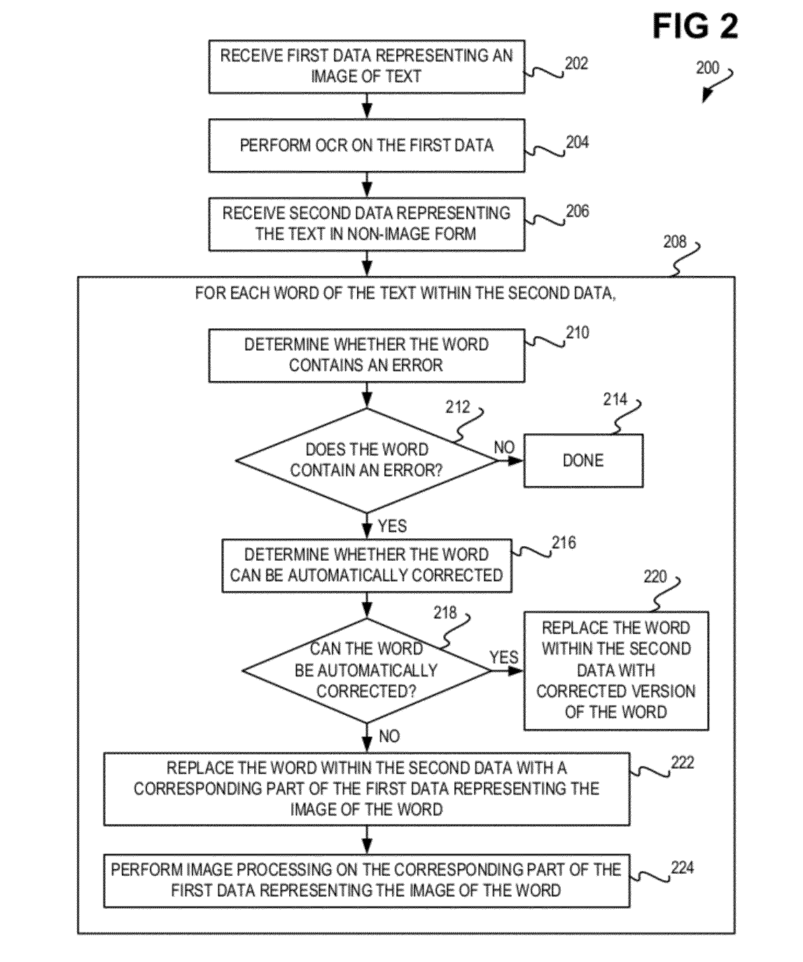

FIG. 2 shows a method 200, according to an example of the disclosure. The method 200 can be performed by a processor of a computing device, such as a desktop or a laptop computer. For example, a non-transitory computer-readable data storage medium may store a computer program, such that execution of the computer program by the processor results in the method 200 being performed. The method 200 can be performed without any user interaction.

First data is received that represents an image of text (202). For example, one or more hardcopy pages of text may have been scanned using a scanning device, resulting in the image of the text. The image may include graphics in addition to the text, or the image may include just text. OCR may be performed on the first data (204). The result of the OCR is second data representing the text of the image but in non-image form and which may be textually editable, where such second data is said to be received (206). Even if part 204 is not performed, the second data representing the text of the image but in non-image form is received in part 206.

For each word of the text within the second data, the following can be performed (208). It may be determined whether the word contains an error (210). For instance, it may be determined, without user interaction, whether the word is located within an electronic dictionary. If the word is located within the dictionary and if the dictionary indicates that the word is being spelled correctly, then it is concluded that the word does not contain an error. By comparison, if the word is not located within the dictionary or if the dictionary indicates that the word is not spelled correctly, then it is concluded that the word does contain an error. Other approaches may also be followed to determine whether the word contains an error.

If the word does not contain an error (212), then the method 200 is finished as to this word (214). However, if the word does contain an error (214), then it may be determined whether the word can be automatically corrected (216), such as without user interaction. For instance, the word may be looked up within an electronic dictionary. If the electronic dictionary includes a corrected version of the word, then it is concluded that the word can be automatically corrected. If the electronic dictionary does not include a corrected version of the word, then it is concluded that the word cannot be automatically corrected. Other approaches may also be followed to determine whether the word can be automatically corrected.

For example, an electronic dictionary that is used for correcting data generated by OCR may indicate that the word “hello,” where the number 11 replaces the letters “II,” is spelled incorrectly (i.e., contains an error), but that the correction version of this word is “hello.” In this respect, such an electronic dictionary may be different than an electronic dictionary that is used primarily for spellchecking during the creation of textual documents by users within computer programs like word processing computer programs. A typical user, for example, is unlikely to type the word “hello” as “hello,” with the number 11 replacing the letters “ll.” However, the user may type the word “hello” as “he . . . o,” where the user incorrectly pressed the period key immediately bellow the letter “l” key instead of the letter “l” key. By comparison, OCR is unlikely to interpret an image of the word “hello” as “he . . . o,” since it is unlikely that an image of the letter “l” will be recognized as a period.

If the word can be automatically corrected (218), then the word is replaced within the second data with a corrected version of the word (220). For instance, the correction version of the word may be determined by looking up the word within an electronic dictionary, as has been described. By comparison, if the word cannot be automatically corrected (218), then the word is replaced within the second data with a corresponding part of the first data representing the image of the word. As such, the second data can include both textual data representing words in non-image form, as well as image data representing other words as images.

Image processing may be performed on the corresponding part of the first data representing the image of the word (224), so that this corresponding part better matches the text as represented within the second data. For example, the image of the word within the first data may be relatively small, whereas the text of the other words within the second data may be specified in a relatively large font size. Therefore, the image of the word within the first data may be resized so that it matches the font size of the text within the second data.

As another example, the image of the word within the first data may represent the word as black text against a gray background. By comparison, the text of the other words within the second data may be specified as being black in color against a white background. Therefore, the background of the image of the word within the first data can be modified so that it better matches the background of the text within the second data. In the example, then, the background of the image of the word within the first data may be modified so that it is white.

The method 200 that has been described can be deviated from without departing from the scope of the present disclosure. For instance, it may not be determined whether a word can be automatically corrected. In this case, the method 200 proceeds from part 212 to part 222, instead of from part 212 to part 216. Furthermore, for a given word, determining whether or not the word contains an error may be omitted in some implementations. As such, for such a given word, part 208 of the method 200 includes just part 222, and potentially part 224 as well.

The definition of a word herein can be one or more characters between a leading space, or a leading punctuation mark, and a lagging space, or a lagging punctuation mark. Examples of punctuation marks include periods, commas, semi-colons, colons, and so on. As such, a word can include non-letter characters, such as numbers, as well as other non-letter characters, such as various symbols. Furthermore, a hyphenated word (i.e., a word containing a hyphen) can be considered as a whole, including both parts of the word, to either side of the hyphen, or each part of the word may be considered individually. In part, whether a hyphenated word is considered as one word or two words depends on whether the definition of a word is defined

For example, consider the word “post-graduate,” which may be an adjective that modifies a subsequent word “degree.” This word may be considered as two words, “post” and graduate,” or it may be considered as one word, “post-graduate.” If the word “post-graduate” is discerned by OCR as “p0st-graduate,” then if the word is considered as two words, an image corresponding to the word “post” will replace the first word in the second data, and the second word “graduate” will not be replaced by an image in the second data. By comparison, if the word is considered as one word, then an image corresponding to the entire word “post-graduate” will replace the word in the second data.

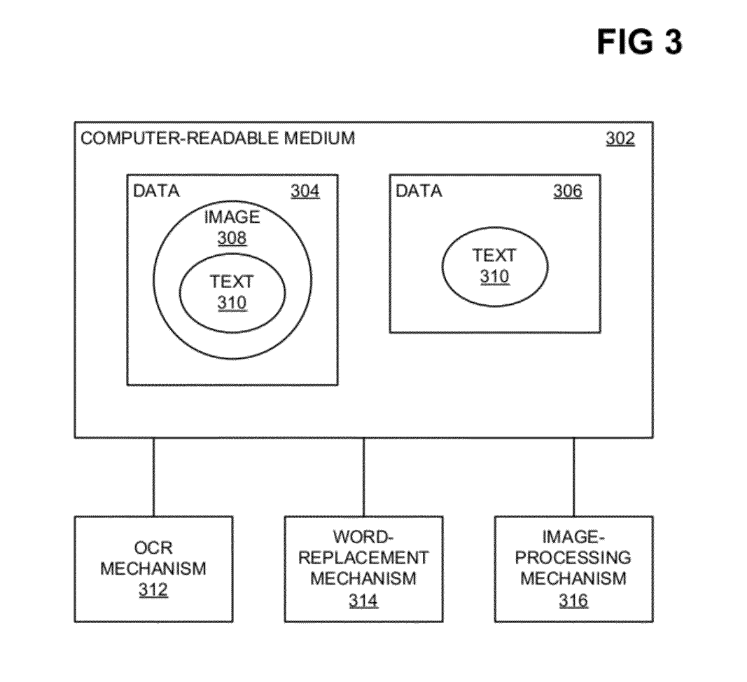

In conclusion, FIG. 3 shows a rudimentary system 300, according to an example of the disclosure. The system 300 may be implemented at one or more computing devices, such as desktop or laptop computers. The system 300 includes a non-transitory computer-readable data storage medium 302. Example of such computer-readable media include volatile and non-volatile semiconductor memory, magnetic media, and optical media, as well as other types of non-transitory computer-readable data storage media.

The computer-readable medium 302 stores data 304 and data 306. The data 304 is the first data that has been described in reference to the method 200, whereas the data 306 is the second data that has been described in reference to the method 200. The data 304 thus represents an image 308 of text 310 that includes words. By comparison, the data 306 represents the text 310 in a non-image form, and which may be textually editable using a computer program like a word processing or text editing computer program.

The system 300 in the example of FIG. 3 includes an OCR mechanism 312, a word-replacement mechanism 314, and an image-processing mechanism 316. The mechanisms 312, 314, and 316 may each be implemented at least in hardware. For example, each mechanism 312, 314, and 316 may be implemented as a computer program stored on a non-transitory computer-readable data storage medium, such that execution of the computer program by the processor of a computing device causes the functionality of the mechanism to be performed. In this respect, each mechanism 312, 314, and 316 is said to be implemented at least in hardware insofar as the non-transitory computer-readable data storage medium and the processor are both hardware.

The OCR mechanism 312, when present, performs OCR on the image 310 of the text 310 represented by the data 304 to generate the text 310 represented by the data 306. Stated another way, the OCR mechanism 312 performs OCR on the data 304 to generate the data 306. The word-replacement mechanism 314 examines each word of the text 310 within the data 306, and replaces each such word with a corresponding part of the image 308 represented by the data 304 as appropriate. As such, the word-replacement mechanism 314 performs at least parts 210-222 of the method 200. Finally, the image-processing mechanism 316 performs image processing on the corresponding parts of the image 308 represented by the data 304 that have been substituted for words within the text 310 represented by the data 306, and as such performs part 224 of the method 200.

We claim:

1. A method comprising:
receiving, by a processor, first data representing an image of text, the text including a plurality of words;
receiving, by the processor, second data representing the text in a non-image form; and,
replacing, by the processor, a particular word within the second data with a corresponding part of the first data representing the image of the particular word.

2. The method of claim 1, wherein the second data is an optical character recognition (OCR) version of the image of the text.

3. The method of claim 1, further comprising performing, by the processor, optical character recognition (OCR) on the first data to generate the second data.

4. The method of claim 1, further comprising determining, by the processor, that the particular word within the second data contains an error,
wherein replacing the particular word within the second data with the corresponding part of the first data representing the image of the particular word is performed where the particular word within the second data contains an error.

5. The method of claim 4, further comprising determining, by the processor, whether the particular word within the second data contains an error by:
determining, without user interaction, whether the particular word is located within a dictionary;
where the particular word is located within the dictionary, concluding that the particular word does not contain an error; and,
where the particular word is not located within the dictionary, concluding that the particular word does contain an error.

6. The method of claim 4, further comprising, where the particular word within the second data contains an error:
determining, by the processor, whether the particular word can be automatically corrected; and,
in response to determining that the particular word can be automatically corrected,
replacing, by the processor, the particular word within the second data with a corrected version of the particular word that is in a non-image form,
wherein replacing the particular word within the second data with the corresponding part of the first data representing the image of the particular word is performed in response to determining that the particular word cannot be automatically corrected.

7. The method of claim 6, wherein determining whether the particular word can be automatically corrected comprises, without user interaction, looking up the particular word within a dictionary to determine whether the dictionary includes the corrected version of the particular word.

8. The method of claim 1, further comprising performing, by the processor, image processing on the corresponding part of the first data representing the image of the particular word so that the corresponding part of the first data better matches the text as represented within the second data.

9. The method of claim 8, wherein performing the image processing on the corresponding part of the first data representing the image of the particular word so that the corresponding part of the first data better matches the text as represented within the second data comprises one or more of:
resizing the corresponding part of the first data to match a font size of the text as represented within the second data;
modifying a background within the image of the particular word within the corresponding part of the first data to match a background of the text as represented within the second data.

10. A non-transitory computer-readable data storage medium having a computer program stored thereon for execution by a processor to perform a method comprising:
receiving first data representing the image of the text, the text including a plurality of words;
receiving second data representing the text in a non-image form; and,
for each word of the text within the second data,
determining whether the word within the second data contains an error;
where the word contains an error, replacing the word within the second data with a corresponding part of the first data representing the image of the word.

11. The non-transitory computer-readable data storage medium of claim 10, wherein the second data is an optical character recognition (OCR) version of the image of the text.

12. The non-transitory computer-readable data storage medium of claim 10, wherein the method further comprises performing optical character recognition (OCR) on the first data to generate the second data.

13. The non-transitory computer-readable data storage medium of claim 10, wherein determining whether the word contains an error comprises:
determining, without user interaction, whether the word is located within a dictionary;
where the word is located within the dictionary, concluding that the word does not contain an error; and,
where the word is not located within the dictionary, concluding that the word does contain an error.

14. The non-transitory computer-readable data storage medium of claim 10, wherein the method further comprises, where the word contains an error:
determining whether the particular word can be automatically corrected; and,
in response to determining that the particular word can be automatically corrected,
replacing the word within the second data with a corrected version of the word that is in a non-image form,
wherein replacing the word within the second data with the corresponding part of the first data representing the image of the word is performed in response to determining that the word cannot be automatically corrected.

15. The non-transitory computer-readable data storage medium of claim 14, wherein determining whether the word can be automatically corrected comprises, without user interaction, looking up the word within a dictionary to determine whether the dictionary includes the corrected version of the word.

16. The non-transitory computer-readable data storage medium of claim 10, where the method further comprises, where the word contains an error, performing image processing on the corresponding part of the first data representing the image of the word so that the corresponding part of the first data better matches the text as represented within the second data.

17. A system comprising:
a computer-readable data storage medium to store:
first data representing an image of text, the text including a plurality of words;
second data representing the text in a non-image form; and,
a mechanism implemented at least in hardware to replace a particular word within the second data with a corresponding part of the first data representing the image of the particular word.

18. The system of claim 17, further comprising another mechanism implemented at least in hardware to perform optical character recognition (OCR) on the first data to generate the second data.

19. The system of claim 17, wherein the mechanism is to further determine that the particular word within the second data contains an error,
and wherein the mechanism is to replace the particular word within the second data with the corresponding part of the first data representing the image of the particular word where the particular word within the second data contains an error.

20. The system of claim 17, further comprising another mechanism to perform image processing on the corresponding part of the first data representing the image of the particular word so that the corresponding part of the first data better matches the text as represented within the second data.
